(19) United States
(12) Patent Application Publication
(10) Pub. No.: US 2025/0004821 A1
(43) Pub. Date: Jan. 2, 2025

(54) PUBLISH-SUBSCRIBE DEVICE AND OPERATING METHOD THEREOF

(71) Applicants: Digiwin Software Co., Ltd, Shanghai (CN); DATA SYSTEMS CONSULTING CO., LTD., New Taipei City (TW)

(72) Inventors: Zhi Zhang, Shanghai (CN); Guoxin Sun, Shanghai (CN)

(73) Assignees: Digiwin Software Co., Ltd, Shanghai (CN); DATA SYSTEMS CONSULTING CO., LTD., New Taipei City (TW)

(21) Appl. No.: 18/462,443

(22) Filed: Sep. 7, 2023

(30) Foreign Application Priority Data
Jun. 28, 2023 (CN) 202310779972.4

(51) Int. Cl. G06F 9/46; G06F 9/54

(52) U.S. Cl. CPC G06F 9/466; G06F 9/542

(57) ABSTRACT

The invention provides a publish-subscribe device and an operating method thereof. The publish-subscribe device includes a memory and a processor. The processor executes a plurality of modules in the memory, and executes a transaction in response to a request command output by an electronic device. The plurality of modules include a transaction publisher, a transaction state manager, and a subscriptions and logic device. The transaction publisher publishes an event to the transaction state manager according to state information of the transaction. The transaction state manager transmits the event to the subscriptions and logic device according to a subscription rule, so that the subscriptions and logic device executes a task associated with the event according to the event, thereby decoupling a business logic to reduce a complexity of implementing an application.

### CROSS-REFERENCE TO RELATED APPLICATION

This application claims the priority benefit of China application serial no. 202310779972.4, filed on Jun. 28, 2023. The entirety of the above-mentioned patent application is hereby incorporated by reference herein and made a part of this specification.

### BACKGROUND OF THE INVENTION

### Field of the Invention

The invention relates to a data processing device, in particular to a publish-subscribe device and an operating method thereof.

### Description of Related Art

An enterprise system may cooperate with a data processing device to initiate and execute an application such as a project, a task, or an activity via a task engine to provide various business services. Generally, when an application is launched, the business logic executed by the data processing device involves the processing logic of the state of a transaction. For example, in the state of transaction commit or transaction rollback, in addition to the main business logic of the application, the processing logic also includes non-related business processing logic corresponding to this state.

However, the current data processing device additionally processes the processing logic related to the transaction state via hard-coding, so that the processing logic and the main business logic are closely coupled, thus increasing the complexity of implementing the application.

### SUMMARY OF THE INVENTION

The invention is aimed at a publishing and subscribing device capable of decoupling business logic to reduce the complexity of implementing an application.

According to an embodiment of the invention, a publish-subscribe device of the invention includes a memory and a processor. The memory stores a plurality of modules. The processor is coupled to the memory and an electronic device. The processor executes the plurality of modules, and executes a transaction in response to a request command output by the electronic device. The plurality of modules include a transaction publisher, a transaction state manager, and a subscriptions and logic device. The transaction publisher publishes an event to the transaction state manager according to state information of the transaction. The transaction state manager transmits the event to the subscriptions and logic device according to a subscription rule, so that the subscriptions and logic device executes a task associated with the event according to the event.

According to an embodiment of the invention, an operating method of a publish-subscribe device of the invention includes the following steps. A memory stores a plurality of modules. A processor executes a transaction in response to a request command output by an electronic device. The processor executes the plurality of modules. The plurality of modules include a transaction publisher, a transaction state manager, and a subscriptions and logic device. The step of executing the plurality of modules includes the following steps. The transaction publisher publishes an event to the transaction state manager according to state information of the transaction. The transaction state manager transmits the event to the subscriptions and logic device according to a subscription rule. The subscriptions and logic device executes a task associated with the event according to the event.

Based on the above, the publish-subscribe device and the operating method thereof of the invention trigger the transaction state manager according to the state information of the transaction via the transaction publisher, and transmit the corresponding event to the subscriptions and logic device via the transaction state manager. The publish-subscribe device may decouple the processing logic of the state of the transaction not related to the main business logic. Moreover, a corresponding task is executed via the subscriptions and logic device, and the publish-subscribe device may independently process the processing logic, so as to reduce the complexity of implementing the application and improve the flexibility of processing business logic.

In order to make the above-mentioned features and advantages of the invention more comprehensible, the following specific embodiments are described in detail with reference to the accompanying drawings.

### BRIEF DESCRIPTION OF THE DRAWINGS

FIG. 1 is a circuit block diagram of a publish-subscribe device of an embodiment of the invention.

FIG. 2 is a flowchart of an operating method of a publish-subscribe device of an embodiment of the invention.

FIG. 3 is a circuit block diagram of a publish-subscribe device of another embodiment of the invention.

FIG. 4 is a flowchart of an operating method of a publish-subscribe device of the embodiment of FIG. 3 of the invention.

FIG. 5A to FIG. 5B are operational diagrams of a publish-subscribe device of an embodiment of the invention.

### DESCRIPTION OF THE EMBODIMENTS

Reference will now be made in detail to the exemplary embodiments of the invention, examples of which are illustrated in the accompanying drawings. Wherever possible, the same reference numerals are used in the drawings and descriptions to refer to the same or like portions.

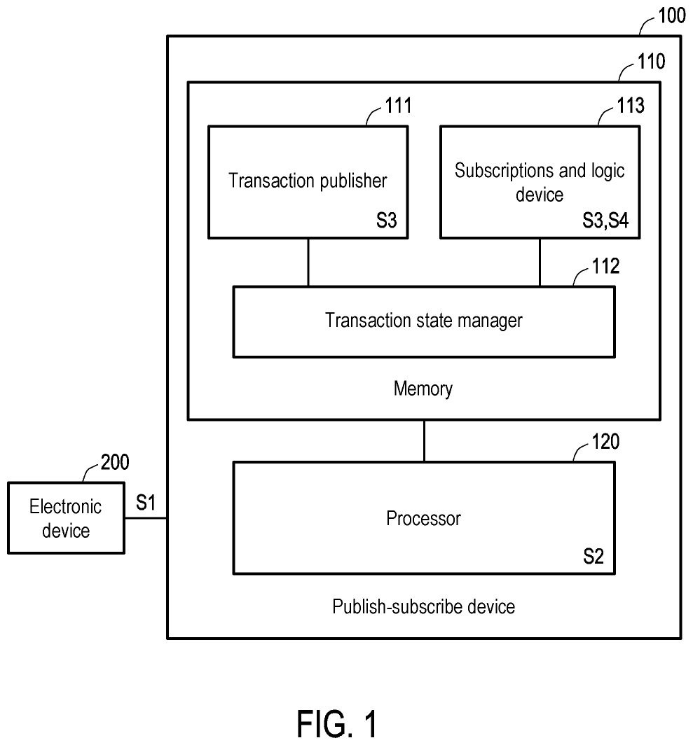

FIG. 1 is a circuit block diagram of a publish-subscribe device of an embodiment of the invention. Referring to FIG. 1, a publish-subscribe device 100 applies publish-subscribe information queue communication.

In the present embodiment, the publish-subscribe device 100 may be set in the cloud for a user to connect to operate the publish-subscribe device 100 via an electronic device 200. The publish-subscribe device 100 may be, for example, a software as a service (SaaS) server, so as to execute a corresponding SaaS application via an application programming interface (API). In some embodiments, the publish-subscribe device 100 may be installed in the ground within an enterprise for the user to connect the publish-subscribe device 100 with another system installed in the cloud via the electronic device 200 to input/output data, so as to accordingly execute the corresponding SaaS application via the API.

In the present embodiment, the user may also operate the user interface of the electronic device 200 to operate an enterprise system (not shown) via the API, and then make the enterprise system operate the publish-subscribe device 100 via an API call, in order to implement various functions (for example, sign off on purchase order) in a business service. In the present embodiment, the electronic device 200 may be, for example, a mobile phone, a tablet computer, a notebook computer, a desktop computer, and the like. The enterprise system may be, for example, an enterprise resource planning (ERP) system.

In the present embodiment, the publish-subscribe device 100 may include a memory 110 and a processor 120. The memory 110 stores a plurality of modules 111 to 113. The modules may be, for example, different components in software to implement corresponding functions respectively. The modules may include a transaction publisher 111, a transaction state manager 112, and a subscriptions and logic device 113. In the present embodiment, the memory 110 may also store computing software and other relevant algorithms, programs, and data for implementing functions of the invention related to processing, various calculations, and software operation. The memory 110 may be, for example, a dynamic random-access memory (DRAM), a flash memory, a non-volatile random-access memory (NVRAM), or a combination of the memories.

In the present embodiment, the processor 120 is coupled to the memory 110 and the electronic device 200. The processor 120 accesses the memory 110, and may execute the data in the memory 110 and the modules 111 to 113, as well as a request command S1 from the electronic device 200. In the present embodiment, the processor 120 may be, for example, a signal converter, a field-programmable gate array (FPGA), a central processing unit (CPU), or other programmable general-purpose or special-purpose microprocessors, digital signal processors (DSPs), programmable controllers, application-specific integrated circuits (ASICs), programmable logic devices (PLDs), or other similar devices or a combination of the devices that may load and execute computer program-related firmware or software to implement functions such as processing, various calculations, and software operation.

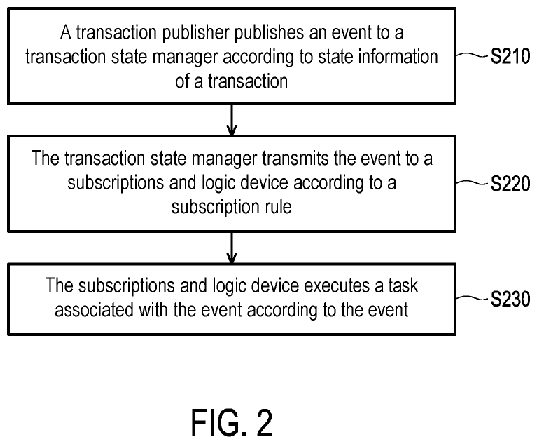

FIG. 2 is a flowchart of an operating method of a publish-subscribe device of an embodiment of the invention. Referring to FIG. 1 and FIG. 2, the publish-subscribe device 100 may execute steps S210 to S230. The order of the steps S210 to S230 is only an example for illustration, and is not limited thereto. In the present embodiment, steps S210 to S230 may be applied to the following exemplary situations.

In the present embodiment, the electronic device 200 outputs the request command S1 to access the publish-subscribe device 100. The processor 120 receives the request command S1 and executes a transaction S2 in response to the request command S1. The transaction S2 is the processing logic when the publish-subscribe device 100 executes business logic, and is formed by a plurality of operation sequences. The transaction S2 may include various states to indicate the currently executed scenario. The state of the transaction S2 may be, for example, BEFORE_COMMIT, AFTER_COMMIT, AFTER_ROLLBACK, or AFTER_COMPLETION. The AFTER_COMPLETION state may be, for example, a rollback, or a commit state.

That is, the electronic device 200 instructs the publish-subscribe device 100 to execute the business logic to implement a target application via the request command S1. In response to the request command S1, the publish-subscribe device 100 executes a main business logic related to the transaction S2 itself, and executes a non-main business logic related to the state of the transaction S2. The non-main business logic may, for example, include sending information related to the current state of the transaction S2 via, for example, SMS, email, or communication software.

In the present embodiment, during the process of executing the transaction S2 via the publish-subscribe device 100, the publish-subscribe device 100 decouples the main business logic and the non-main business logic by performing steps S210 to S230.

In step S210, the processor 120 executes the transaction publisher 111, so that the transaction publisher 111 publishes an event S3 to the transaction state manager 112 according to the state information of the transaction S2. In the present embodiment, the state information of the transaction S2 may be, for example, the state of the transaction S2, a change in the state of the transaction S2, or a combination of the above. The event S3 may be, for example, an executable program corresponding to the transaction S2 to instruct the processor 120 to execute the non-main business logic of the current transaction S2.

In step S220, the processor 120 executes the transaction state manager 112, so that the transaction state manager 112 transmits the event S3 to the subscriptions and logic device 113 according to the subscription rule. In the present embodiment, the subscription rule may be, for example, a default rule of the publish-subscribe device 100 to instruct the transaction state manager 112 to which subscriptions and logic device 113 to push the event S3.

In step S230, the processor 120 executes the subscriptions and logic device 113, so that the subscriptions and logic device 113 executes a task S4 associated with the event S3 according to the event S3. In the present embodiment, the task S4 is an executable program corresponding to the non-main business logic of the event S3 to instruct the processor 120 to send information related to the current state of the transaction S2.

It is worth mentioning here that during the process of accessing the publish-subscribe device 100, via the transaction state manager 112 being triggered in response to the state information of the transaction S2, the publish-subscribe device 100 may decouple the non-main business logic of the state of the transaction S2, thereby reducing the complexity of implementing the application. Moreover, via the subscriptions and logic device 113 executing the task S4 corresponding to the state of the transaction S2, the publish-subscribe device 100 may independently execute the non-main business logic related to the transaction S2, thereby improving the flexibility of executing the business logic.

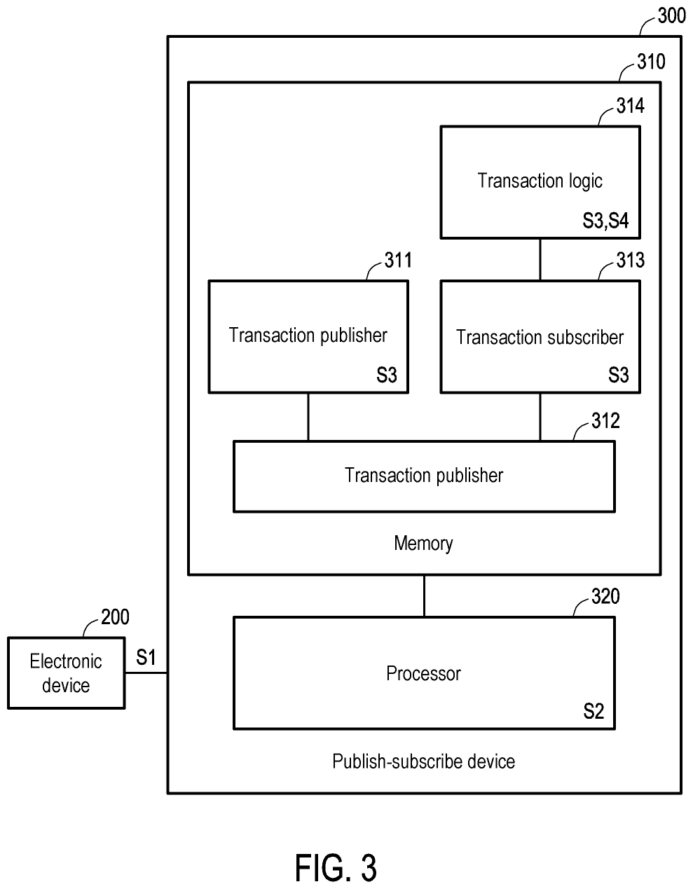

FIG. 3 is a circuit block diagram of a publish-subscribe device of another embodiment of the invention. Referring to FIG. 3, a publish-subscribe device 300 may include a memory 310 and a processor 320. The memory 310 stores a plurality of modules 311 to 314 such as a transaction publisher 311, a transaction state manager 312, a transaction subscriber 313, and a transaction logic device 314. The memory 310, the processor 320, and the modules 311 to 314 are as provided in the relevant description of the publish-subscribe device 100 and may be analogized as such.

In the present embodiment, the transaction subscriber 313 and the transaction logic device 314 may be, for example, another implementation of the subscriptions and logic device 113 in the embodiment of FIG. 1. That is, the subscriptions and logic device 113 of FIG. 1 may include at least one transaction subscriber 313 and at least one transaction logic device 314.

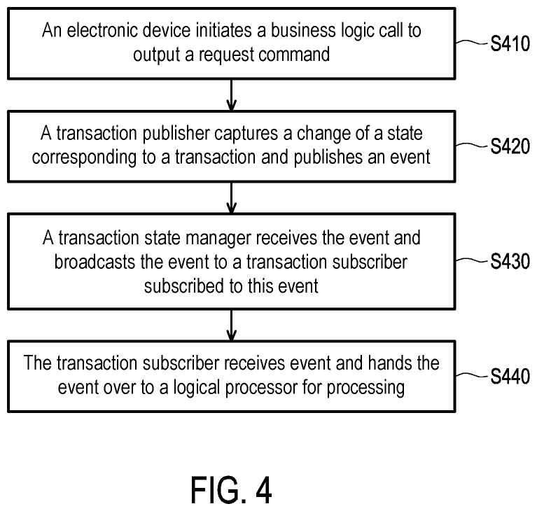

FIG. 4 is a flowchart of an operating method of a publish-subscribe device of the embodiment of FIG. 3 of the invention. Referring to FIG. 3 and FIG. 4, the publish-subscribe device 300 may execute steps S410 to S440. The order of the steps S410 to S440 is only an example for illustration, and is not limited thereto. In the present embodiment, steps S410 to S440 may be applied to the following exemplary situations.

In the process of starting the application, the publish-subscribe device 300 executes the plurality of modules 311 to 314 via the processor 310 to default the program (e.g., subscription rule) of business logic. In detail, the transaction subscriber 313 subscribes to the transaction state manager 312 for at least one state change of the transaction S2. That is, the transaction subscriber 313 registers (i.e., subscribes to) the state change of the interested transaction S2 into the transaction state manager 312.

In the present embodiment, the state change of the transaction S2 may exist, for example, in the form of the event S3, so that the transaction subscriber 313 may subscribe to the state change of the transaction S2. The state change of the transaction S2 (that is, the event S3) may be implemented, for example, in JSON (JavaScript Object Notation), Extensible Markup Language (XML), or YAML, etc. However, the invention is not limited thereto.

In the process of running the application, the electronic device 200 and the publish-subscribe device 300 cooperate to implement the target application. The publish-subscribe device 300 executes the plurality of modules 311 to 314 via the processor 310 to execute the non-main business logic related to the state of the transaction S2. In detail, in step S410, the electronic device 200 initiates a business logic call via the API to output the request command S1. In response to the request command S1, the publish-subscribe device 300 executes the transaction S2 to implement the business logic corresponding to the request command S1.

In step S420, the transaction publisher 311 captures the change in the state of the corresponding transaction S2 and publishes the event S3 to illustrate the implementation details of step S210. In the present embodiment, in response to the state change of the transaction S2, the transaction publisher 311 encapsulates the state information of the transaction S2 into the event S3. The state information includes the change in the state of the transaction S2. The transaction publisher 311 publishes the event S3 to the transaction state manager 312.

Next, the transaction state manager 312 receives the event S3 sent from the transaction publisher 311. In response to receiving the event S3 associated with the state of the transaction S2, the transaction state manager 312 sends receipt acknowledgment information to the transaction publisher 311.

It should be noted that the transaction publisher 311 adopts an event-driven approach. Therefore, when the event-driven condition is met (i.e., the state of the transaction S2 is changed), the transaction publisher 311 is enabled to encapsulate the change in the state of the transaction S2 into the event S3. Furthermore, the transaction publisher 311 does not pay attention to the object (i.e., the transaction subscriber 313) subscribed to the event S3. The transaction publisher 311 only needs to publish the event S3 to the transaction state manager 312.

In step S430, the transaction state manager 312 receives the event S3 and broadcasts the event S3 to the transaction subscribers 313 subscribed to the event S3 to illustrate the implementation details of the step S220. In the present embodiment, the transaction state manager 312 traverses all subscribed transaction subscribers 313 to transmit the event S3 to the subscribed transaction subscriber(s) 313 according to the subscription rule. In other words, the transaction state manager 312 traverses one or a plurality of transaction subscribers 313 in the transaction state manager 312 subscribed to (i.e., register for) the state change (i.e., the event S3) of the transaction S2. The transaction state manager 312 broadcasts the event S3 to the transaction subscriber(s) 313 according to the subscription rule.

In the present embodiment, the transaction state manager 312 acts as a bridge between the transaction publisher 311 and one or a plurality of transaction subscribers 313. For the transaction publisher 311, the transaction state manager 312 provides a receiving function related to the event S3. For the transaction subscriber 313, the transaction state manager 312 provides the function of subscribing (i.e., registering), the function of unsubscribing (i.e., logging out), and the function of publishing (i.e., broadcasting) the event S3.

It should be noted that the transaction state manager 312 may ensure that the event S3 related to the state change of the transaction S2 may be correctly subscribed according to the subscription rule. In addition, the transaction state manager 312 may correctly broadcast the event S3 to the corresponding transaction subscriber 313 according to the subscription rule to execute a subsequent processing logic. In this way, the transaction state manager 312 may simplify processes such as subscription and publication of the event S3.

In step S440, the transaction subscriber 313 receives the event S3 and sends the event S3 to the logic processor 314 for processing, to illustrate the implementation details of the step S230. In the present embodiment, the transaction subscriber 313 receives and stores the event S3. The transaction subscriber 313 transmits the event S3 to the corresponding one or plurality of logical processors 314. The logical processor(s) 314 execute(s) the task S4 associated with the event S3 according to the event S3 to generate task result information.

In detail, the transaction subscriber 313 receives the event S3. The transaction subscriber 313 saves the event S3 in the publish-subscribe device 300. In response to receiving the event S3, the transaction subscriber 313 sends receipt confirmation information to the transaction state manager 312. Moreover, the transaction subscriber 313 transmits the event S3 to one or a plurality of logic processors 314 to notify the logic processor(s) 314 to execute a corresponding processing logic (i.e., the task S4).

Continuing with the above description, the logic processor 314 receives the event S3. The logic processor 314 executes the task S4 according to the event S3 to perform the non-main business logic regarding the state of the transaction S2. In the present embodiment, the state of the transaction S2 may be, for example, the abnormal rollback of the transaction related to the task storage. Corresponding to the state of the transaction S2, the task S4 can, for example, initiate the processing logic of notifying a task executor (that is, a certain user) information, so as to send information related to the abnormal rollback of the transaction to the corresponding user in various ways.

In the present embodiment, one or a plurality of logic processors 314 executing the task S4 generate corresponding task result information, and return the task result information to the corresponding transaction subscriber 313. That is, after the logic processor 314 completes the execution of the task S4, a corresponding execution result (i.e., task result information) is added and recorded. In addition, the logic processor 314 returns the task result information to the transaction subscriber 313.

In the present embodiment, one or a plurality of transaction subscribers 313 in the subscriptions and logic device unsubscribe from the transaction state manager 312 for a change in the state of the transaction S2. In other words, when the transaction subscriber 313 does not need to subscribe to whether the state of the transaction S2 is changed, the transaction subscriber 313 unsubscribes from the transaction state manager 312 (that is, logs out) for the relevant information previously subscribed by the transaction subscriber 313. In the present embodiment, the transaction state manager 312 updates the subscription rule. In this way, when the state of the transaction S2 is changed, the transaction state manager 312 stops transmitting the event S3 to the transaction subscriber 313 and the logic processor 314 in the subscriptions and logic device according to the updated subscription rule.

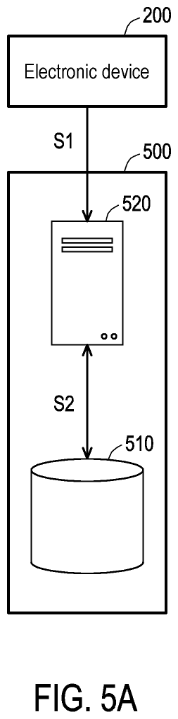

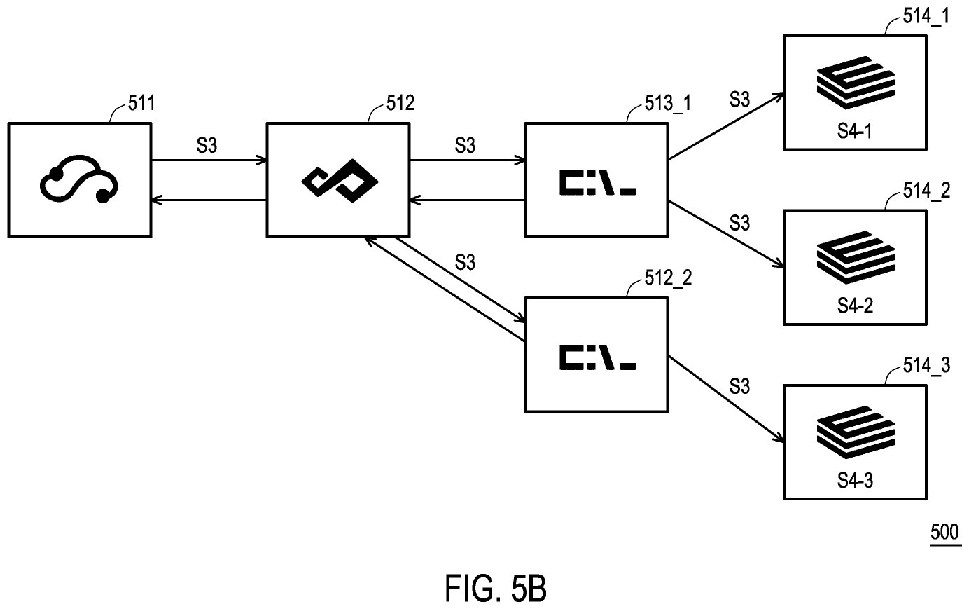

FIG. 5A to FIG. 5B are operational diagrams of a publish-subscribe device of an embodiment of the invention. Referring to FIG. 5A to FIG. 5B, a publish-subscribe device 500 may include a memory 510 and a processor 520. The memory 510 stores a plurality of modules 511 to 514_3 such as a transaction publisher 511, a transaction state manager 512, a plurality of transaction subscribers 513_1 to 513_2, and a plurality of transaction logic device 514_1 to 514_3. The memory 510, the processor 520, and the modules 511 to 514_3 are as provided in the relevant description of the publish-subscribe device 300 and may be analogized as such.

In the present embodiment, the transaction subscribers 513_1 to 513_2 in the publish-subscribe device 500 are a plurality. The transaction subscribers may include the plurality of transaction subscribers 513_1 to 513_2 according to the business domain. That is, the transaction subscribers 513_1 to 513_2 may be divided into various granularities via the business domain to process the subscribed event S3 accordingly.

In the present embodiment, the transaction logic devices 514_1 to 514_3 in the publish-subscribe device 500 are a plurality. The transaction logic devices may include the plurality of transaction logic units 514_1 to 514_3 according to the business domain, and are used to execute various processing logics. For example, the transaction logic devices 514_1 and 514_2 have the same business domain and are used to execute different processing logics. The transaction logic device 514_3 and the transaction logic devices 514_1 to 514_2 have different business domains, and are used to execute another processing logic.

In FIG. 5A, the electronic device 200 initiates a task to execute a target application via a business logic call, thereby outputting the request command S1 to the publish-subscribe device 500. In response to the request command S1, the processor 520 accesses the memory 510, and initiates and executes the transaction S2.

In FIG. 5B, when the processor 520 executes the transaction S2, the transaction publisher 511 monitors whether the state of the transaction S2 is changed. When the state of the transaction S2 is changed, the transaction publisher 511 encapsulates the change (i.e., state information) in the state of the transaction S2 into the event S3 and publishes the event S3.

Next, the transaction state manager 312 receives the event S3. The transaction state manager 312 forwards (i.e., broadcasts) the event S3 to the subscribed transaction subscribers 513_1 to 513_2 according to the subscription rule. In the present embodiment, each of the transaction subscribers 513_1513_1 to 513_2 transmits the event S3 to the transaction logic devices 514_1 to 514_3 associated with their respective business domains, to illustrate the implementation details of step S440.

Specifically, since the transaction subscriber 513_1 has the first business domain, the transaction subscriber 513_1 notifies the transaction logic devices 514_1 to 514_2 related to the first business domain to execute the corresponding first processing logic (i.e., tasks S4-1 to S4-2) according to a business domain rule. Furthermore, the transaction subscriber 513_2 has a second business domain. The transaction subscriber 513_2 notifies the transaction logic device 514_3 related to the second business domain to execute the corresponding second processing logic (i.e., a task S4-3) according to the business domain rule.

Continuing the above description, the transaction logic devices 514_1 to 514_3 receive the event S3 respectively. The transaction logic devices 514_1 to 514_3 respectively perform additional operations (i.e., various processing logics) according to the event S3. In the present embodiment, corresponding to a specific event S3, the same transaction subscriber 513_1 may associate and execute the corresponding non-main business logic via the plurality of transaction logic devices 514_1 to 514_2. For example, it is assumed that the event S3 indicates that the state of the transaction S2 is changed to AFTER_COMMIT. The transaction logic 514_1 executes the first task S4-1 by initiating the activity processing logic according to the event S3 from the transaction subscriber 513_1. The transaction logic unit 514_2 executes the second task S4-2 by executing the operation and maintenance module processing logic according to the event S3 from the transaction subscriber 513_1. In addition, the transaction logic 514_3 executes the third task S4-3 via other processing logics according to the event S3 from the transaction subscriber 513_2.

In some ways, in a known publish-subscribe device (such as a Kafka system), a host (called a broker in the Kafka system) implements a publish-subscribe operation via a push-pull mode. In detail, based on the registered subscription center set independently by the Kafka system, one or a plurality of producers push the transaction information to the broker to publish the transaction information. Based on the registered subscription center, one or a plurality of consumers pull the subscribed transaction information by themselves. In other words, the publish-subscribe operation executed by the Kafka system has nothing to do with the state of the transaction. Furthermore, the Kafka system does not have processing components set up to execute the processing logic regarding the state of the transaction.

It should be noted that, compared with the conventional Kafka system, the publish-subscribe device 500 implements the publish-subscribe operation via the push-push mode. Specifically, the publish-subscribe device 500 drives the transaction publisher 511 to publish based on the state change of the transaction S2, and further drives the transaction state manager 512 to forward the information associated with the transaction S2 (i.e., the event S3) to the subscribed transaction subscribers 513_1 to 513_3 and the corresponding transaction logic devices 514_1 to 514_3. That is, the publish-subscribe device 500 executes the publish operation based on the state of the transaction S2. Moreover, the publish-subscribe device 500 may divide the applications of different consumption business scenarios via the transaction logic devices 514_1 to 514_3 in various business fields, so as to refine the processing logic related to the state of the transaction S2. Moreover, the publish-subscribe device 500 may manage the transaction publisher 511 and the transaction subscribers 513_1 to 513_3 uniformly according to the subscription rule via the transaction state manager 512.

Based on the above, the publish-subscribe device and the operating method thereof of the invention adopt the transaction state publish-subscribe mechanism to implement decoupling, thereby reducing the complexity of executing the application and improving the flexibility of executing various business logics. By executing the publish operation in response to the state information of the transaction using the transaction state manager, the publish-subscribe device may decouple the non-main business logic of the state of the transaction, and may implement the non-main business logic independently. In this way, the publish-subscribe device may satisfy the effects of high cohesion and low coupling in software system design. Moreover, executing the corresponding non-main business logic according to the business domain via the transaction subscriber and the transaction logic device, the publish-subscribe device may dynamically implement the processing logic of various transaction states according to different business requirements.

Lastly, it should be noted that: the above embodiments are only used to illustrate the technical solutions of the invention, rather than to limit them. Although the invention has been described in detail with reference to the above embodiments, those of ordinary skill in the art should understand that: the technical solutions described in the above embodiments may still be modified, or equivalent replacements for some or all of the technical features may be performed. However, these modifications or replacements do not make the essence of the corresponding technical solutions depart from the scope of the technical solutions of the embodiments of the invention.

What is claimed is:

1. A publish-subscribe device, comprising:
a memory storing a plurality of modules; and
a processor coupled to the memory and an electronic device to execute the plurality of modules and execute a transaction in response to a request command output by the electronic device, wherein the plurality of modules comprise a transaction publisher, a transaction state manager, and a subscriptions and logic device,
wherein the transaction publisher publishes an event to the transaction state manager according to state information of the transaction, and the transaction state manager transmits the event to the subscriptions and logic device according to a subscription rule, so that the subscriptions and logic device executes a task associated with the event according to the event.

2. The publish-subscribe device of claim 1, wherein the state information comprises a change in a state of the transaction.

3. The publish-subscribe device of claim 1, wherein in response to a change in a state of the transaction, the transaction publisher encapsulates the state information into the event.

4. The publish-subscribe device of claim 1, wherein the subscriptions and logic device comprises at least one transaction subscriber and at least one transaction logic device,
wherein the at least one transaction subscriber stores the event, and the at least one transaction logic device executes the task to generate task result information.

5. The publish-subscribe device of claim 4, wherein the at least one transaction subscriber subscribes to the transaction state manager for at least one state change of the transaction.

6. The publish-subscribe device of claim 4, wherein the at least one transaction logic device returns the task result information to the at least one transaction subscriber.

7. The publish-subscribe device of claim 4, wherein the transaction state manager traverses the subscribed at least one transaction subscriber to transmit the event to the subscribed at least one transaction subscriber according to the subscription rule.

8. The publish-subscribe device of claim 4, wherein the at least one transaction subscriber comprises a plurality of transaction subscribers according to a business domain.

9. The publish-subscribe device of claim 8, wherein the at least one transaction logic device is a plurality, and each of the plurality of transaction subscribers transmits the event to the plurality of transaction logic devices associated with the business domain.

10. The publish-subscribe device of claim 1, wherein the subscriptions and logic device unsubscribes from the transaction state manager for a change in a state of the transaction, so that the transaction state manager updates the subscription rule to stop transmitting the event to the subscriptions and logic device.

11. An operating method of a publish-subscribe device, comprising:
storing a plurality of modules via a memory;
executing a transaction via a processor in response to a request command output by an electronic device; and
executing the plurality of modules via the processor, wherein the plurality of modules comprise a transaction publisher, a transaction state manager, and a subscriptions and logic device, comprising:
publishing an event to the transaction state manager according to state information of the transaction via the transaction publisher;
transmitting the event to the subscriptions and logic device according to a subscription rule via the transaction state manager; and
executing a task associated with the event according to the event via the subscriptions and logic device.

12. The operating method of claim 11, wherein the state information comprises a change in a state of the transaction.

13. The operating method of claim 11, wherein the step of executing the plurality of modules further comprises:
encapsulating the state information into the event via the transaction publisher in response to a change in a state of the transaction.

14. The operating method of claim 11, wherein the subscriptions and logic device comprises at least one transaction subscriber and at least one transaction logic device, wherein the step of executing the plurality of modules further comprises:
storing the event via the at least one transaction subscriber; and
executing the task via the at least one transaction logic device to generate task result information.

15. The operating method of claim 14, wherein the step of executing the plurality of modules further comprises:
subscribing to the transaction state manager for at least one state change of the transaction via the at least one transaction subscriber.

16. The operating method of claim 14, wherein the step of executing the plurality of modules further comprises:
returning the task result information to the at least one transaction subscriber via the at least one transaction logic device.

17. The operating method of claim 14, wherein the step of executing the plurality of modules further comprises:
traversing the subscribed at least one transaction subscriber via the transaction state manager to transmit the event to the subscribed at least one transaction subscriber according to the subscription rule.

18. The operating method of claim 14, wherein the at least one transaction subscriber comprises a plurality of transaction subscribers according to a business domain.

19. The operating method of claim 18, wherein the at least one transaction logic device is a plurality, and the step of executing the plurality of modules further comprises:
transmitting the event to the plurality of transaction logic devices associated with the business domain via each of the plurality of transaction subscribers.

20. The operating method of claim 11, wherein the step of executing the plurality of modules further comprises:
unsubscribing from the transaction state manager for a change in a state of the transaction via the subscriptions and logic device; and
updating the subscription rule via the transaction state manager to stop transmitting the event to the subscriptions and logic device.
